(19) United States
(12) Patent Application Publication
(10) Pub. No.: US 2020/0061478 A1
(43) Pub. Date: Feb. 27, 2020

(54) REAL-TIME ANALYTICS AND COACHING IN ATHLETICS AND COMPETITIONS

(71) Applicant: Jason Kopf, Madison, WI (US)

(72) Inventor: Jason Kopf, Madison, WI (US)

(21) Appl. No.: 16/539,440

(22) Filed: Aug. 13, 2019

Related U.S. Application Data
(60) Provisional application No. 62/720,268, filed on Aug. 21, 2018.

(51) Int. Cl. A63F 13/87; A63F 13/86; A63F 13/79

(52) U.S. Cl. CPC A63F 13/87; A63F 2300/577; A63F 13/79; A63F 13/86

(57) ABSTRACT

A method for providing real-time coaching assistance during a competition. The method includes providing a gameplay profile containing rules for competing in the competition and receiving input data relating to the competition via an input device in real-time. The method further includes analyzing in real-time via a processing module the input data in view of the gameplay profile for the competition, automatically generating coaching outputs in real-time based on the analysis of the input data, and displaying in real-time the coaching outputs on a display device. The coaching outputs include performance statistics for a plurality of players, and also include an attempt projection for a future event to occur during the competition. The real-time coaching assistance is provided by displaying the coaching outputs.

### CROSS REFERENCE TO RELATED APPLICATIONS

This application claims the benefit of U.S. Provisional Patent Application No. 62/720,268, filed Aug. 21, 2018, which is incorporated herein by reference in its entirety.

### FIELD

The present disclosure generally relates to analytics and coaching in athletics and other competitions, and more particularly to systems and computer-executable programs performing real-time analysis from a plurality of inputs to provide real-time analytics and consequent coaching recommendations in preparation for or during an event.

### BACKGROUND

The Background and Summary are provided to introduce a foundation and selection of concepts that are further described below in the Detailed Description. The Background and Summary are not intended to identify key or essential features of the potentially claimed subject matter, nor are they intended to be used as an aid in limiting the scope of the potentially claimed subject matter.

It is customary practice for a coach and players to review statistics and highlights of both their own team and an opponent, particularly in preparation for an upcoming competition. This often includes the review of video footage, such as to study the patterns and behaviors of a competitor. While the specific data and mechanisms for reviewing opponents may vary by the sport or other competition, some degree of study appears to be common across nearly any competitive endeavor.

Various other features, objects and advantages of the disclosure will be made apparent from the following description taken together with the drawings.

### SUMMARY

This Summary is provided to introduce a selection of concepts that are further described below in the Detailed Description. This Summary is not intended to identify key or essential features of the claimed subject matter, nor is it intended to be used as an aid in limiting the scope of the claimed subject matter.

One embodiment of the present disclosure generally relates to a method for providing real-time coaching assistance during a competition. The method includes providing a gameplay profile containing rules for competing in the competition and receiving input data relating to the competition via an input device in real-time. The method further includes analyzing in real-time via a processing module the input data in view of the gameplay profile for the competition, automatically generating coaching outputs in real-time based on the analysis of the input data, and displaying in real-time the coaching outputs on a display device. The coaching outputs include performance statistics for a plurality of players, and also include an attempt projection for a future event to occur during the competition. The real-time coaching assistance is provided by displaying the coaching outputs.

Another embodiment generally relates to a non-transitory medium having instructions thereon for providing real-time coaching assistance during a competition that, when executed by a processing device, causes a computing device operated by a user to access a gameplay profile containing rules and a play area map for the competition. The non-transitory medium also causes the computing device to receive input data relating to the competition via an input device in real-time, to analyze in real-time the input data in view of the gameplay profile for the competition, and to automatically generate coaching outputs in real-time based on the analysis of the input data. The coaching outputs include performance statistics for a plurality of players and also an attempt projection for a future event to occur during the competition. Displaying in real-time the coaching outputs on a display device to thereby provide real-time coaching assistance.

### BRIEF DESCRIPTION OF THE DRAWINGS

The drawings illustrate embodiments for carrying out the disclosure. The same numbers are used throughout the drawings to reference like features and like components. In the drawings:

FIG. 1 depicts an exemplary system incorporating an analysis and coaching engine to generate outputs based on inputs according to the present disclosure;

FIG. 2 depicts an exemplary real-time interface providing outputs according to the present disclosure, such as may be provided by the system of FIG. 1;

FIG. 3 depicts an exemplary scheme for dividing a playing area into zones, which may be incorporated into the inputs of FIG. 1 and/or the outputs of FIG. 2;

FIGS. 4A-4D depict exemplary interfaces for viewing and entering data into a system, such as that shown in FIG. 1;

FIG. 5 depicts an exemplary system according to the present disclosure configured to be integrated within a cloud-based network; and

FIGS. 6-8 depict exemplary structures for entering and storing data according to the present disclosure.

### DETAILED DISCLOSURE

This written description uses examples to disclose embodiments of the present application and also to enable any person skilled in the art to practice or make and use the same. The patentable scope of the invention is defined by the potential claims and may include other examples that occur to those skilled in the art. Such other examples are intended to be within the scope of the claims if they have structural elements that do not differ from the literal language of the claims, or if they include equivalent structural elements with insubstantial differences from the literal language of the claims.

Through research and experience in the field, the present inventor has identified that the data available for the preparation and real-time execution of an athletic or other competition is woefully inadequate in the modern world. In particular, while it seems that more and more data has become available, there is presently no known system for effectively managing this problem of “big data,” leaving players, coaches, agents, and the like in either paralysis, or in the dark.

The present disclosure generally relates to systems and computer-executable programs for receiving and managing inputs from a wide variety of sources, analyzing this data to identify trends and predictions not previously available, and providing beneficial outputs in the form of real-time reporting and coaching assistance, selecting the most relevant A/V (audio/video) feeds or archived footage to review (and when), providing summaries of a participant, player, own team, and/or opposing team in preparation for, during, or after a competition, and/or presenting real-time play or outcome predictions.

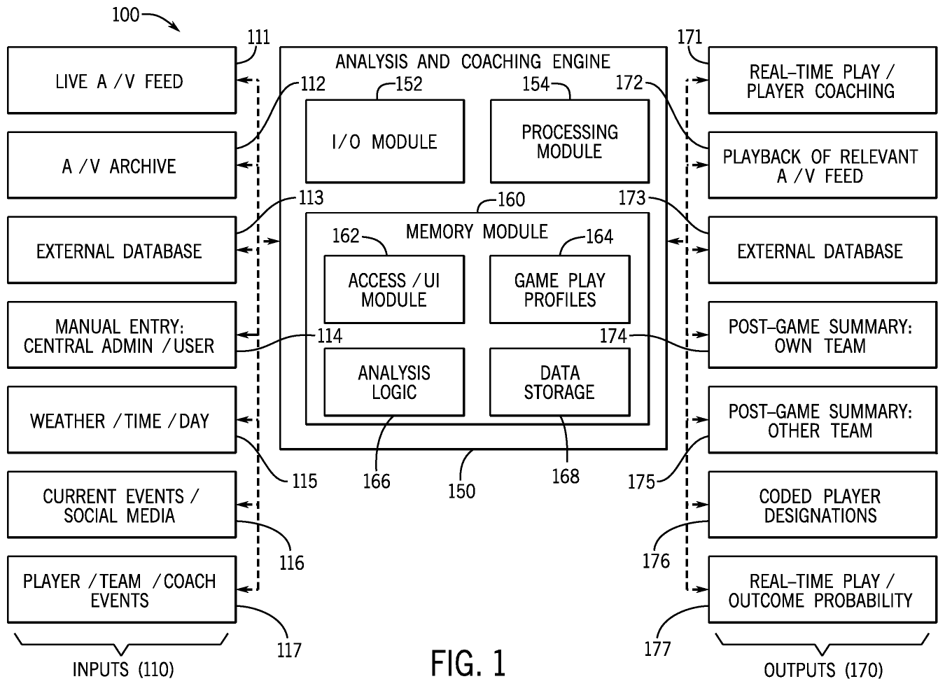

In the exemplary system 100 shown in FIG. 1, an analysis and coaching engine 150 receives data from a plurality of inputs 110. By way of example, these inputs 110 may include a live A/V feed 111, such as from a video camera permanently or temporarily installed within a given venue or arena. In further embodiments, this live A/V feed 111 may include or be supplemented with various tracking technologies, such as RFID, facial recognition, infrared sensing, and the like. Additional exemplary inputs 110 include data from an A/V archive 112, such as that previously stored from a live A/V feed 111 or other sources, external databases 113, and/or manually entered data 114 from a central administrator or a user. Additionally, the present system 100 incorporates data relating to weather, time, and day 115, such as the temperature and pressure for a present competition, or that which corresponds to historic competitions or data stored in other inputs, such as the external database 113. Similarly, inputs 110 may include current events or social media events 116, such as a recent political event, terrorist incident within the vicinity, or positive or negative press relating to a competitor and/or the location in which the competition will take place. In this manner, the system 100 is configured to identify patterns of behavior or performance for a team from a city in the midst of very positive or very negative vibes. For example, football pass completions may improve following a natural disaster, whereby the team is particularly focused to “win one for the community.” This, in turn may impact the recommendations of the analysis and coaching engine 150 for the opposing team, such as to bias plays and formations best suited for passing coverage. Finally, player, team, and coach events 117 may be incorporated as inputs 110, such as the hiring or firing of a coach, additions and losses of competitors, arrests, positive and negative press, additions and losses of a personal nature, such as the birth of a child or loss of a relative, and the like.

These exemplary inputs 110 are received within the analysis and coaching engine 150 via an I/O (input/output) module 152, which also communicates between the analysis and coaching engine 150 and the outputs 170 to be discussed below. The I/O module 152 is further provided in communication with a processing module 154 and a memory module 160. In the exemplary analysis and coaching engine 150 shown, the memory module 160 further includes an Access/UI (user interface) module 162, a game play profiles module 164, an analysis logic module 166, and a data storage module 168. The Access/UI module 162 shown manages access to view, modify, and/or add data within the memory module 160, and/or control access for users to the system 100 more generally. For example, the players, teams, conferences, and the like may be available based on subscription level.

The Game Play Profiles module 164 may store the particular rules, strategies, and other parameters for a wide variety of sports and other competitions. For example, the durations of game play, rules for a player being “off sides”, and various formations and plays may be stored for analysis and identification. In an exemplary embodiment, the analysis and coaching engine 150 can then identify and alert a coach to notify the referee if an opposing player is identified to be off sides. Over time, the analysis and coaching engine 150 may further identify which players have a tendency of being offsides, informing a coach to monitor that player more closely.

The Analysis Logic Module 166 stores the algorithms and logic for operation of the analysis and coaching engine 150, including statistical models, facial and other recognition models, and the specific instructions for receiving inputs 110 and communicating outputs 170, for example. This logic may also include trade secret techniques for predicting outcomes, prioritizing real-time recommendations, and identifying strategies/preparation focuses.

Incoming raw data, such as from the inputs 110, as well as the products of the analysis and coaching engine 150, are storable in the data storage module 168. Data may reside here long-term (depending, for instance on the availability and connectivity with external databases 113 and 173), and/or until results are delivered as outputs 170.

It should be recognized that the memory module 160 may include further modules therein, or may combine or segregate the subject matter stored within the modules in a different manner than shown. The processing module 154, in executing the instructions and parameters stored within the memory module 160, therefore generates a plurality of outputs 170 to be used in preparation for or during a competition as previously discussed. Exemplary outputs 170 include real-time play player coaching 171 (such as may be displayed on a visual display, for example), playback of relevant A/V feeds 172, or the transmission of output data to an external database 173. Additional exemplary outputs 170 include post-game summaries for one's own team 174, and/or another team 175. As will be further discussed below, outputs 170 may also or alternatively include coded player designations 176, particularly in the context of a visual display, as well as a real-time play or outcome probability 177. These outputs 170 provide real-time guidance for coaches and players to make informed decisions through unprecedented access and processing of a wide variety of inputs and predictions.

The system 100 may be used in a wide variety of applications, depending in part upon the user thereof. In certain embodiments, an in-game mode provides statistics with trend analysis for current games, as well as previous games, further allowing queries to identify particular statistics for a given team, player, or set of circumstances. These queries or statistics further allow users to customize a number of points of interest, rather than accepting merely the typical statistics provided in the art, such as a 3-point percentage rate. For example, the system 100 permits a user to selectively determine a given player's free throw percentage based upon the opposing team, which player is guarding the player of interest, the time of day, the game within the overall season (such as the final playoff game), and/or the minutes remaining in the game. For coaches, the system 100 may be used for pregame analysis to identify the tendencies of an opposing team as well as their own team, which may useful to determine the most effective plays in both offense and defense contexts. Pregame analysis may further include recommendations for specific historic film footage to watch, which may be stored in the A/V archive 112 previously discussed. Moreover, the system 100 can identify which plays have not been run against a particular opposing team (or not for a long time), further making suggestions to catch the opposing team off guard.

In contrast to systems known in the art, the system 100 further provides the advantage of specifically recommending film footage of interest, and particular indexed plays therein, searchable based upon the players, teams, and game events shown therein. For example, the system 100 may recommend videos of interest showing a same player performing a same maneuver in a similarly situated game in the past. In an example of an opposing team setting up for a particularly long field goal, the system 100 may recommend previous footage in which a field goal fake was not only attempted, but successful. By suggesting this particular footage, the system 100 helps coaches and players identify when the same play is being run again. This enables the coaches and players to select the best formation to prevent such an outcome, which in certain embodiments may also or alternatively be expressly displayed (i.e., “Fake field goal likely—Run blitz”).

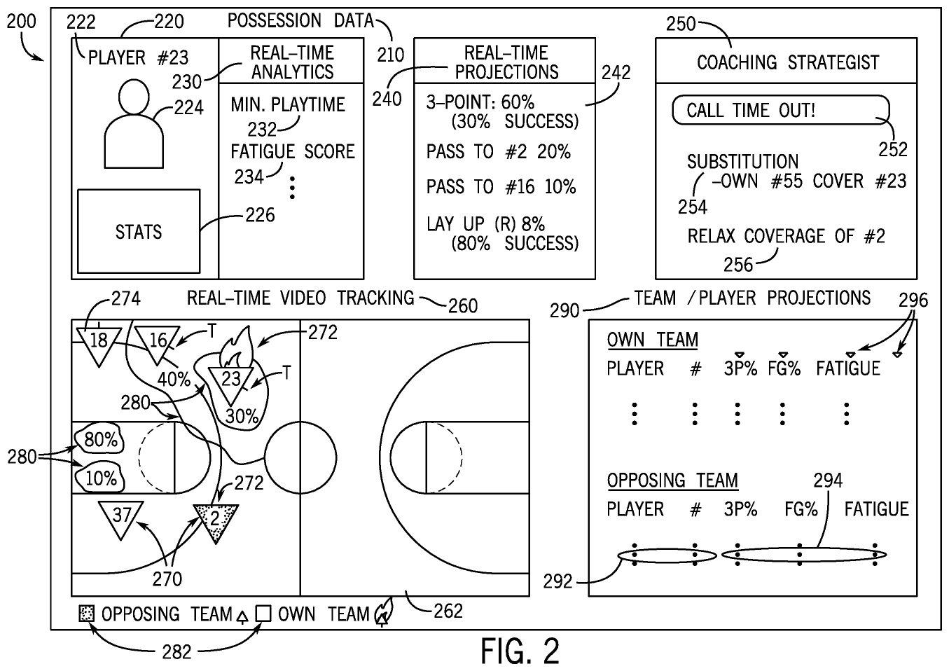

FIG. 2 depicts an exemplary real-time interface 200 for interacting with the system 100, such as on a digital tablet device and/or the like. In the embodiment shown, the real-time interface 200 is configured to generally display possession data 210, a coaching strategist 250, real-time video tracking 260, and team/player projections 290. It should be recognized that each of these sections is fully configurable by the user, such as to display any of the data previously discussed as being outputable by the analysis and coaching engine 150.

In the example shown, the possession data 210 includes a player profile 220, real-time analytics 230, and real-time projections 240. The player profile 220 may include the player ID 222, photo 224, and stats 226 of a player of particular interest, or a player with current possession of the ball or other object of interest. In fast-moving competitions, a key player may be defaulted rather than a player in current possession of a ball, for example, since possession may be changing too quickly to be beneficial. For example, the possession data 210 may default to showing data for a point guard, pitcher, or special teams receiver when a kickoff is imminent.

The possession data 210 in the real-time interface 200 presently shown further includes a display of real-time analytics 230, which is presently shown as including a playtime 232 for the player shown within the player profile 220, as well as a fatigue score 234 determined by the analysis and coaching engine 150 for this player. The fatigue score 234 may be calculated based on a number of trade secret factors, including the minutes of play time 232 for the present competition, but also including analytics outputs from the analysis and coaching engine 150 such as calculated speed of the player, comparisons to historic performance, and any changes in accuracy (for example, a reduction in field goal percentage over time) that the analysis and coaching engine 150 perceives to be attributable to fatigue. The number of games played versus rested in recent days may also be considered, for example.

The real-time interface 200 further includes a display of real-time projections 240, which lists the possible next moves or plays, along with their percentage of occurrence and rate of success, calculated by the analysis and coaching engine 150 based on the player's location and movement, the circumstances and time within the current competition, and historic data analyzed for the user. In the example shown, the real-time projections 240 provides an event listing 242 predicting a sixty percent chance of a 3-point shot (having a thirty percent rate of success based on the player's present location), a twenty percent chance of the player passing to player #2, a ten percent chance of the player passing to player #16, and an eight percent chance of the player attempting a layup on the right side of the basket (with an eighty percent chance of success upon such an attempt). It should be recognized that the event listing 242 may be sorted by most probable to least probable or by most likely to result in a score by the other team or another adverse event. The real-time projection 240 is further configurable to limit the number of projections and type of projections shown within the event listings 242, in part to solve the problem of excessive data available to the coaches and other users.

The real-time interface 200 further includes a coaching strategist 250, which in the present embodiment displays recommendations for plays and other actions to call. In certain embodiments, the coaching strategist 250 acts as an artificial intelligence by which the plays and decisions may be called without the need for an actual coach. The coaching strategist 250 not only provides recommended plays, such as calling a time out as recommendation one 252, but also identifies responses to trends and behaviors that may not have been visible to the coach or are based on historic data and calculations by the analysis and coaching engine 150 not known by the coach. In the example shown, recommendation two 254 calls for a substitution such that player #55 on one's own team is substituted to cover player #23 on the opposing team, which as will be described later is identified as being on a hot streak. In contrast, recommendation three 256 calls for relaxed coverage of player #2, which is indicated as presently having a slump in performance and thus not requiring equal attention and concentration.

In certain embodiments, real-time video tracking 260 is provided, whereby players are monitored using video cameras or other tracking devices such as RFID to determine the location, speed, and direction of travel within the field or other area of competition. In the example shown, the real-time video tracking is provided over a court overview 262, since the present example relates to basketball. Shown within the court overview 262 is a plurality of player icons 270 each corresponding to one of the players on the court. Through selections of the selectable features 282, such as showing the opposing team and/or one's own team, player icons 270 may be shown or hidden. In addition to showing the location and direction of travel (i.e. with tail T) for a given player, the player icons 270 in certain embodiments further include player coding 272 in addition to player number information 274. In certain embodiments, the player coding 272 includes such icons as a flame when a player is having a hot streak or is “on fire,” or may include color coding, such as a player icon 270 being shown darker or in black (or lighter/white, or other colors) when a player is performing poorly, has a poor fatigue score 234, or is otherwise identified as providing a lesser threat under the present circumstances, such as player #2 in the present example.

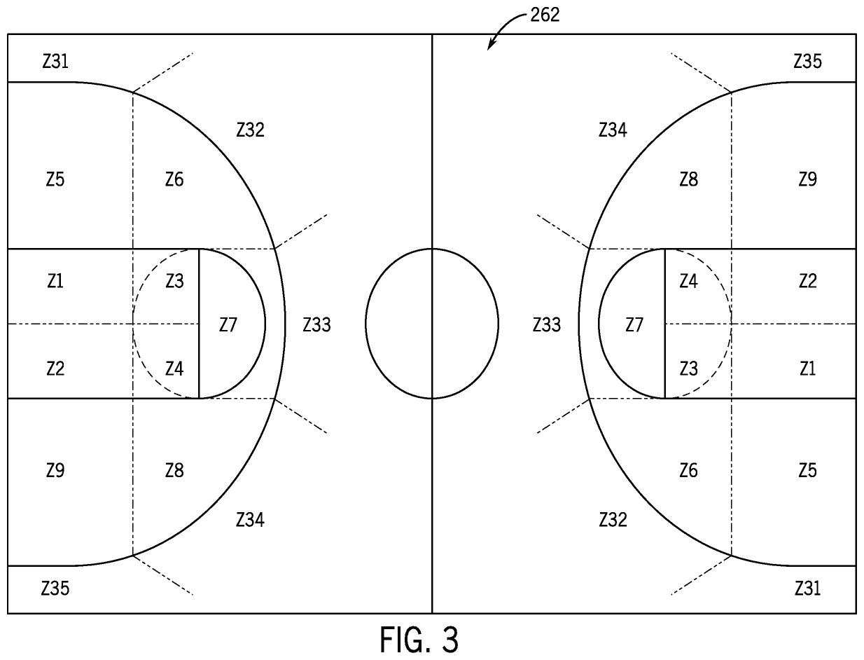

The real-time video tracking 260 presently shown further includes a topographical success rate map 280, which shows the percent success rate for the player scoring a point from that corresponding position. For example, player #23 is presently shown within a thirty percent success rate within the topographical success rate map 280, whereby moving somewhat closer to the left side would increase the projected success rate to forty percent. In the embodiment shown, the topographical success rate map 280 is specific for the player in possession of the ball, shown here as player #23, which further shows an eighty percent success rate from the right side of the basket (such as in a layup), in contrast to ten percent when approaching from the left. As with the other data shown, this topographical success rate map 280 provides invaluable insight into the optimal positions for guarding the player to prevent such an outcome. In certain embodiments, the topographical success rate map 280 may instead or additionally include an overlay showing the percent probability of the player taking such an action, rather than the success rate if such an action is attempted. In certain embodiments, tracking of data and/or the topographical success rate map 280 one is based on different zones Z21-29 and Z31-35 of the playing area, for example, as shown in FIG. 3.

It should be recognized that while the present real-time video tracking 260 example shows the opposing team as having player icons 270 shaped as directional triangles or trees, and the own team as circled arrows, other forms of player icons 270, as well as player coding 272, and player number identification 274, are also anticipated by the present disclosure. Moreover, the court overview 262 should be recognized as corresponding to the particular sport or competition in question, which may otherwise include a soccer field, race track, tennis court, football, hockey, or any other venue in which a competition takes place.

In a manner similar to that shown in the real-time projections 240 within the possession data 210, team/player projections 290 are provided to show an overall overview for the players of one's own team as well as the opposing team, updated in real-time. While the team/player projections 290 display is fully configurable via selectable features 296, the present display is shown as listing the IDs 292 and relevant statistics 294 for some or all of the players on both teams.

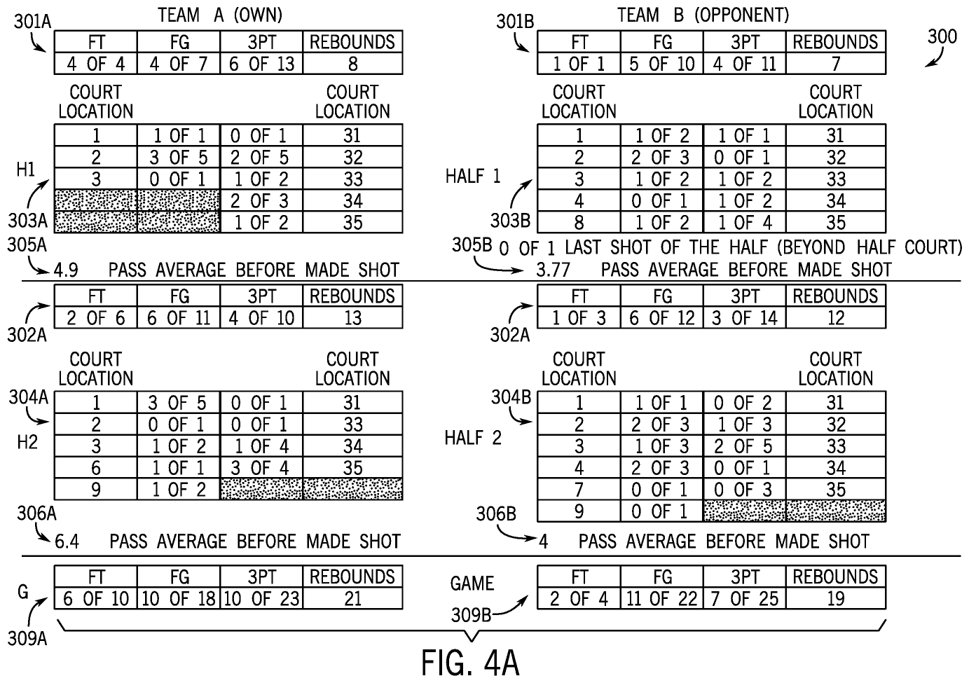

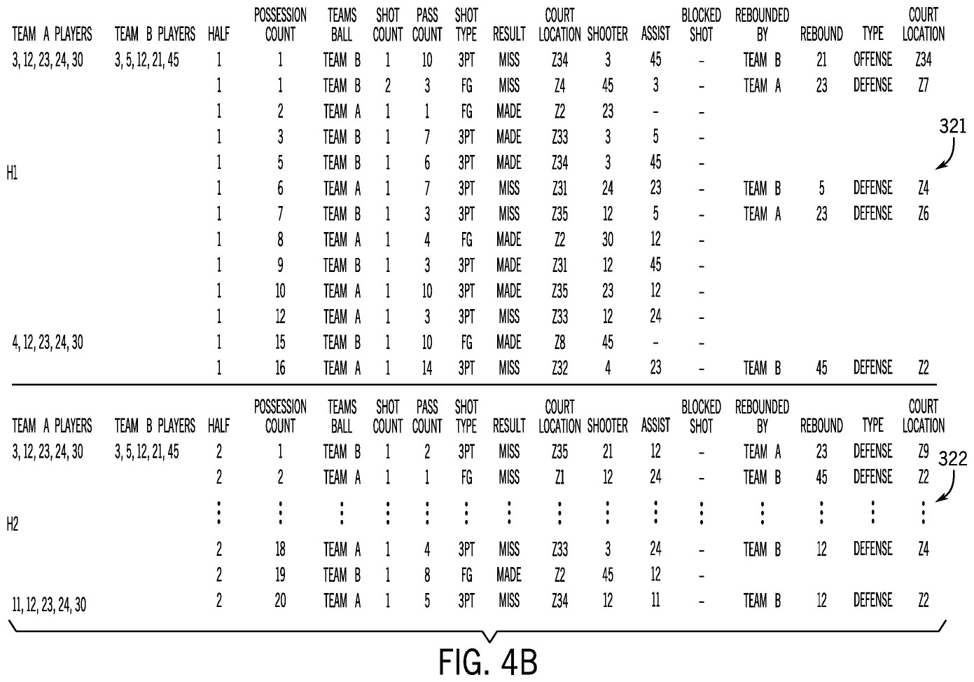

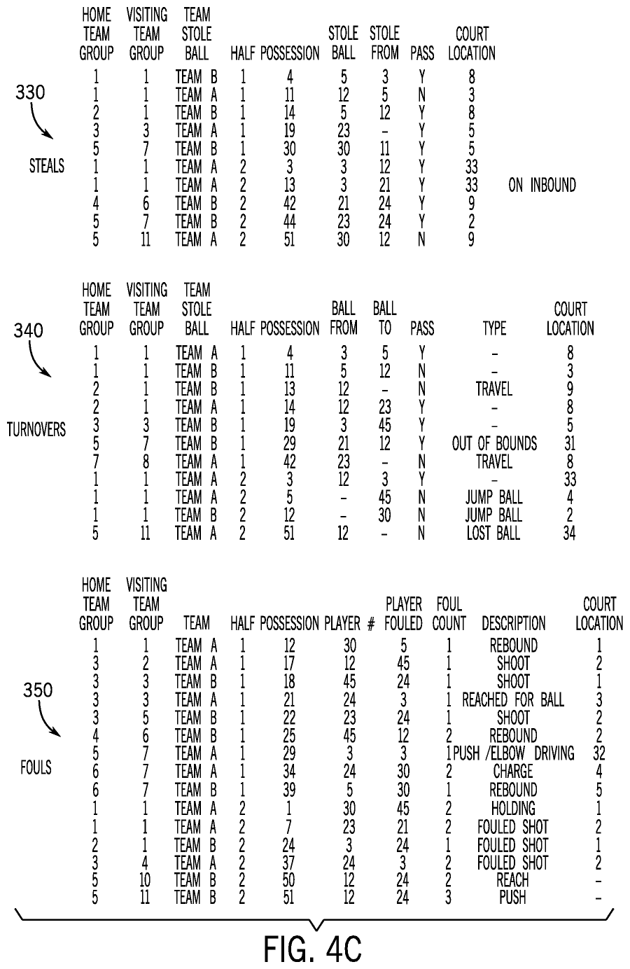

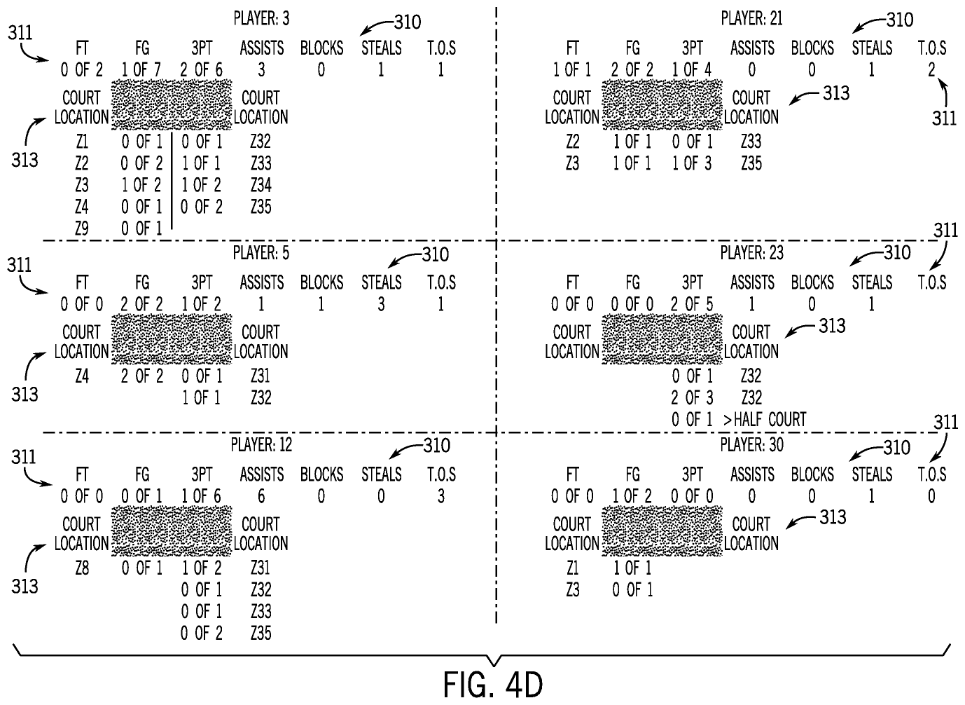

Alternate interfaces are anticipated for viewing data (for example, FIGS. 4A and 4D) as well as entering data (for example, FIGS. 4B and 4C) according to the present disclosure. In the embodiment shown, summary information is provided in the exemplary alternative display shown on FIG. 4A. FIG. 4A shows data divided into half one H1, half two H2 and the entire game G for two teams, in this case continuing the example of the basketball game. The information shown includes summary information 301A, 301B corresponding to half one H1, in this example for the success versus attempt counts of free throws, field goals, three point shots, and rebounds 14A versus Team B, respectively. Similar summaries 302A, 302B and 309A, 309B are provided for half two H2 and the game G as well. Summary information further includes success rates based on the court location or zone taken, shown as references 303A and 303B for half one H1, 304A and 304B for half two H2.

Additional summaries may also be made, such as showing a pass average (or number of passes) averaged before a shot is made shown as 305A, 305B and 306A, 306B for half one H1 and half two H2 for the respective teams. In this manner, coaches or other users may quickly see how their own team or the opponent's team is performing, either during a game, after a game, or in advance of a future game for research purposes. It should also be recognized that these summary fields may be customized according to the desires of the coach, and/or the particular competition of interest. Similar summaries 310 may be provided on a player basis, whether for one's own team or the opponent's team, as shown in FIG. 4D. In this example, the summaries 310 may include overall summaries 311 similar to those shown on a team level in FIG. 4A as reference 301A, as well as shot success rates by location as 313, similar to the team level data provided as 303A. It should be recognized that the players shown in the display of FIG. 4D may be prioritized by those presently playing in a game, starters, individually selected, those with the highest or best performing statistics, or other configurable metrics.

Data may also or alternatively be displayed and/or initially entered into the systems presently disclosed in the manners shown in FIGS. 4B and 4C. In the example of FIG. 4B, data 321 is entered in sequential order for half one H1 and subsequently data 322 for half two H2. This data includes which players are presently playing, shot and pass counts, types of shots, the result, and the corresponding zone or court location, as well as additional data relevant for the particular competition. This data then feeds into the automatic processing and outputs generated by the analysis and coaching engine 150 as previously discussed.

As shown in FIG. 4C, the data from FIG. 4B may be supplemented with data particularly entered with respect to steals 330, turnovers 340, and/or fouls 350. Once again, this prospective data may be entered sequentially, either separately or in conjunction with the data entered into FIG. 4B. It should be recognized that the particular fields for entry and/or viewing may be configured for the individual competition, and the preferences of the coach or other user. Additional exemplary information to be inputted into the data shown in FIGS. 4B, 4C, and elsewhere include whether the defensive team is presently in a man-to-man versus zone formation, whether either team is presently in a power play (in the example of hockey), and/or how many fouls a particular player or team has accumulated at a particular instant.

It should be recognized that this data may be provided from a wide variety of sources, as previously discussed with respect to the inputs 110 discussed above. For example, data may be entered from an external database 113, which may store player and team information within a particular school or club, conference, or across an entire league. Additionally, data may be entered by administrators providing access to the presently disclosed system 100, for instance as a software as a service (SaaS) package, or by individual coaches or players themselves. In addition to manually entering the data, data may be automatically entered through processing by the analysis and coaching engine 150 of a live A/V feed 111, such as identifying the locations of players on the field and outcomes based on the recognition of landmarks within such a feed. Data may also be entered through the use of external sensors, such as RFID tags or biometric imaging landmarks placed on one's own player that can be sensed to track positions, speeds, and general behaviors of a player in action. Such data may be used to populate the fatigue score 234, such as by identification of reduced speed or response time as a game progresses.

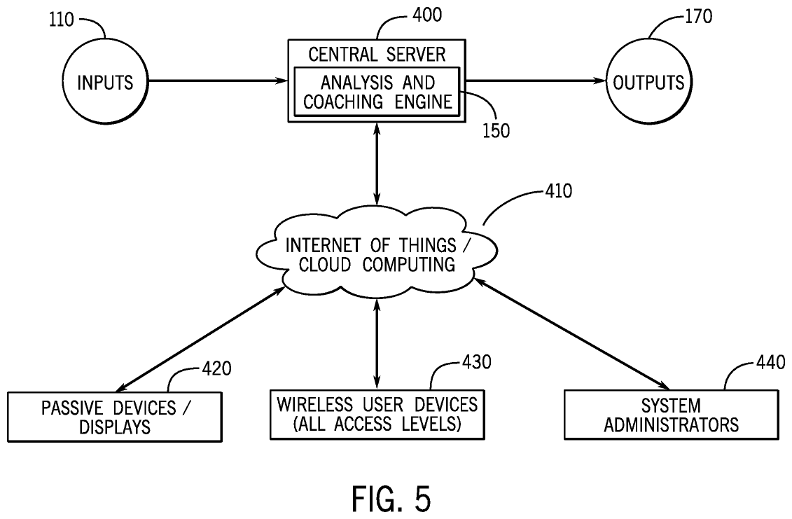

FIG. 5 shows an exemplary embodiment for implementing a system according to the present disclosure. In the embodiment shown, a central server 400 is provided in communication with the analysis and coaching engine 150, whether internally or externally incorporated therewith. The central server 400 is further provided in communication with both the inputs 110 and outputs 170, including those previously discussed with respect to FIG. 1. The central server 400 may be further divided into multiple local or regional servers, or consolidated as shown.

The central server 400 communicates with other devices through the internet or cloud 410 which provides wireless access between the central server 400 and passive devices or displays 420, wireless user devices 430, or system administrator devices 440. For example, the central server 400 may incorporate the logic and data associated with the analysis and coaching engine 150, which is accessible in real-time on devices remote locations (including wired and wireless communication therebetween). Exemplary wireless user devices 430 include laptops, tablets, and smartphones usable by coaches, players, and the like. In this manner, a wireless user device 430 need not be capable of handling the analysis and/or storage necessary to provide the functions of the analysis and coaching engine 150, but instead merely engage with a properly equipped central server 400 through the cloud 410. It will also be recognized that this cuts down on the response time for entering or accessing data via the wireless user devices 430, which are fed by the central server 400.

Similarly, the configuration of FIG. 5 enables system administrator devices 440 to engage with the central server 400 remotely, enabling use of remote office locations for entering and reviewing data, or even entering or accessing the central server 400 in real-time from an actual event. For example, a system administrator using a system administrator device 440 may enter data into the central server 400 from the bleachers of a sporting event, providing real-time data for analysis by the analysis and coaching engine 150 and further processes described herein.

It should be recognized that some of the inputs 110, and outputs 170 may also be connected to the central server 400 via the cloud 410, such as the central server 400 accessing data from a weather server. Similarly, the exemplary devices shown connected via the cloud 410, including passive devices and displays 420, wireless user devices 430, and system administrator devices 440, may themselves constitute inputs 110 and/or outputs 170. For example, in the situation in which a system administrator device 440 is used to input data into the central server 400 from the bleachers of a game in real-time, the system administrator devices 440 would constitute inputs 110. Likewise, the exemplary embodiment of a scoreboard enabled as a passive device/display 420 to provide real-time statistics, score information, and the like would constitute an output 170 of the analysis and coaching engine 150.

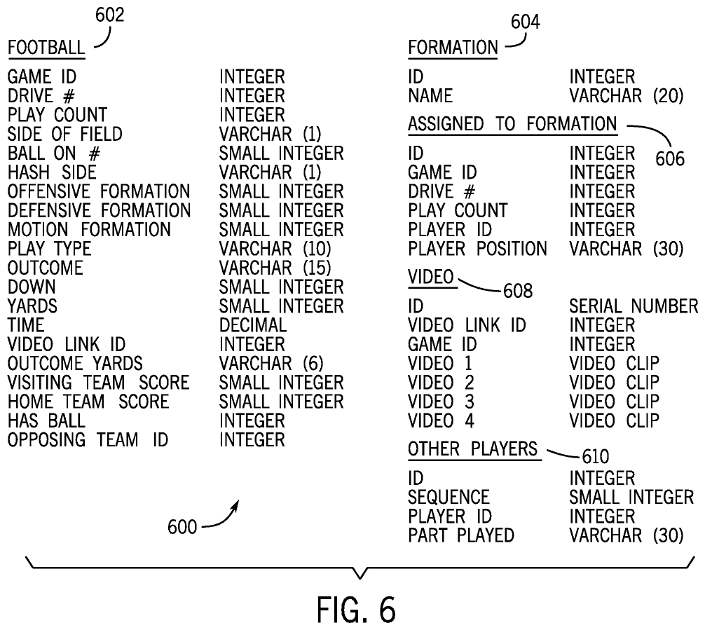

FIGS. 6-8 depict exemplary embodiments for structuring the data and analysis within the analysis and coaching engine 150 (or as an input 110 or output 170), including the storage of the memory module 160. For example, the structure 600 shown in FIG. 6 depicts variables to store and analyze data corresponding to the game of football 602. In this example, the present down is stored as a small integer, a video link ID is stored as an integer, and the play type is stored as a character variable having ten or fewer characters. The specific data structure for each of these variables may also be structured in different ways, as would be known to one of ordinary skill in the art.

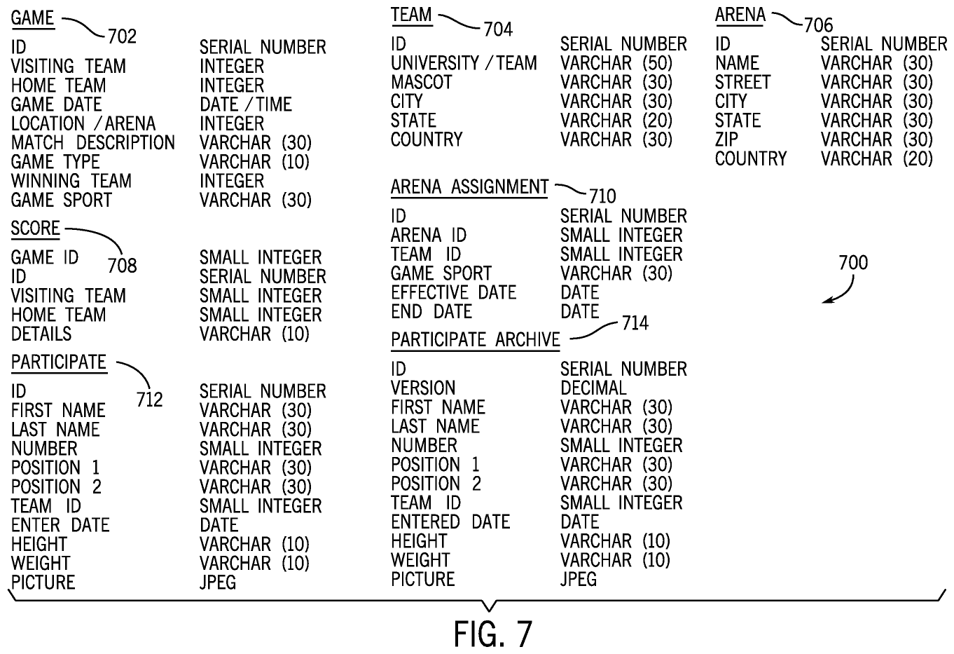

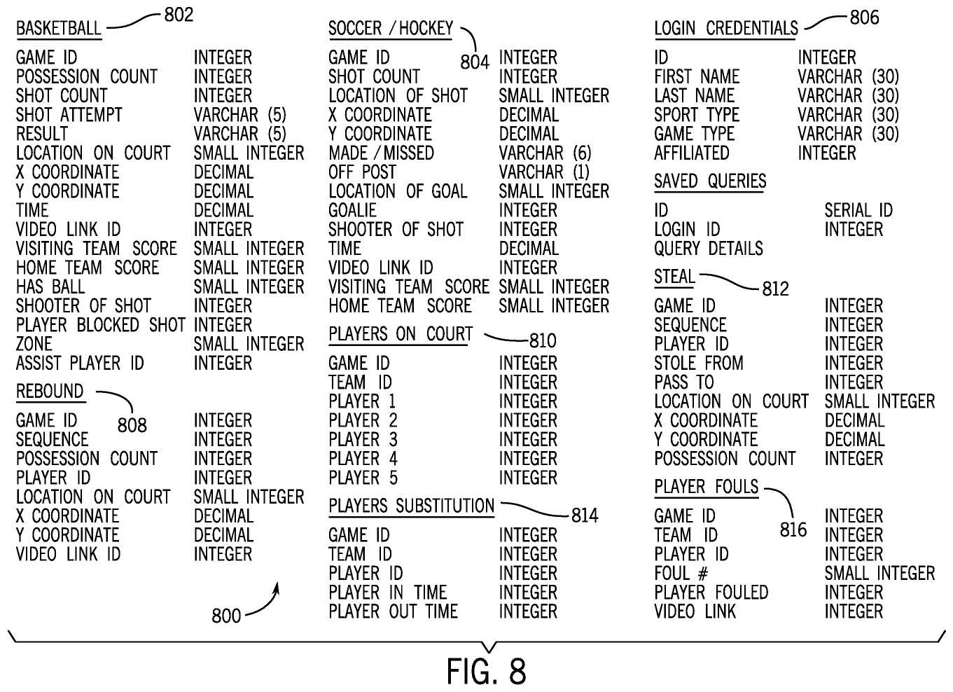

Similar data may be stored for basketball 802, soccer and/or hockey 804, and/or any other competition, such as shown in FIG. 8. Additional data also includes login credentials 806, such as a user ID or other access information, as well as (for the example of basketball) rebound data 808, the particular players on the court 810, player substitutions 814, steal data 812, and player fouls 816, which was previously discussed with respect to the displays shown in FIGS. 4A and 4D. Similar data is also shown in FIG. 7, including high level data associated with a particular game 702, including the teams at play, match descriptions, and which team won. Team 704 data may also be stored, such as a team ID, which university or other affiliation corresponds to the team, as well as the mascot and location for the team. Arena data 706 may also be stored, such as the Fisery Forum in Milwaukee, Wis., including identification and location information, which may also include the type of arena (enclosed or open air), capacity, and/or the like. Score data 708 may also be stored in the manner shown in FIG. 7, as well as arena assignments 710, data associated with participants 712 in the competition, and participant archive data 714, including the heights, weights, and pictures for players corresponding to the particular game of interest. It should further be recognized that the structures of FIGS. 6 and 8 depict only a small portion of the data anticipated for storage and analysis of the analysis and coaching engine 150, and the configuration of the devices and systems disclosed herein.

Additional exemplary inputs 110 include a time zone, location, roster, and/or referees associated with a particular competition of interest. Likewise, additional exemplary outputs 170 include automatically sending game statistics to WIAA or other organizations, databases associated with recruiting and drafting committees, visual displays, and/or the like. In addition to the descriptions provided above, the present inventor has identified the following as additional exemplary data to be provided as inputs 110 and/or outputs 170 resulting from analysis by the analysis and coaching engine 150. Additional users, applications, and exemplary search inquiries are also provided.

### Additional Inputs

Timezone
Location (field, stadium)
Roster
Referees

### Additional Sport-Specific Examples of Inputs

### Basketball:

Inbound plays
Shots made and shots missed
   time and period of shot
   location on the court of shot include grid location
Note: grid location will be a breakdown of traditional 2pt and 3pt. Some embodiments have 5 sections for a 3pt shot and 5 sections for a 2pt shot to allow more detailed tracking of shot location
Rebounds
Steals
Penalties
Turnovers
Players on the court and the statistics acquired for that group (like points, rebounds, steals, and turnovers)

### Football:

coin flip, the person that flipped the coin and the result
when timeout is called
specific player location in a play
offense vs defense formations and the outcome
play called ratio (pass vs run) including details like . . .
   down and distance for each play
   time and period of play
   score of the game
   location on the field
down and distance averages
punt and return also kickoff and return
penalties

### Soccer/Hockey:

Scores and shots on goal
   time and period of play
   location of shot and grid location
   if score, the location on the goal of the score
Penalties
For Soccer, tracking things like corner kicks
For Hockey, tracking things like face-offs and power-plays

### Additional Outputs

Automatically send game statistics to WIAA or other organizations that requires (or would like) the information
Assist with recruiting and draft choice
   Providing in-depth details on how an athlete plays and has grown over their career
Recommending a player switch
   Either a substitution, or coverage
Recommending specific player development
   i.e., this player's rebound rate is much less with players over 6′3″->suggest targeting exercises that improve jump height
Recommending formation changes, positions of players, etc, in real-time
Recommend tendencies for penalties that referees call
Recommend tendencies for penalties opposing team commits
   This could then provide recommendations during the game

### Additional Sport-Specific Examples of Outputs

### Football:

Recommend/predict a next play or series of plays
   Offense: snap count, audible, motion
   Defense: blitz, motion, predict trap or chop block
   Predict key player in next play
Recommend/predict taking a timeout
Recommend what to guess for coin flip (i.e., upon identifying that particular referee does not flip 50/50)
Recommendations for kicking/returning kickoffs or punts

### Basketball:

Recommend substitutions
Recommend guarding assignments
Recommend where to go for a rebound when opposing team is shooting or boxing out a player
Recommend place(s) to trap or pressure opposing team or specific player
Recommend inbound plays to run versus a specific team based on effectiveness and/or the team has seen the play before

### Soccer/Hockey:

Recommend who should be in a faceoff
Recommendation for Power-Play plays or shots
Recommendation for clearing the puck when down a player (opposing team has Power-Play)
Recommend where to shot from
Recommend where on goal to aim/put the ball or puck
Recommendation for corner or penalty kicks
Recommendation for penalty shots

In the above description, certain terms have been used for brevity, clarity, and understanding. No unnecessary limitations are to be inferred therefrom beyond the requirement of the prior art because such terms are used for descriptive purposes and are intended to be broadly construed. The different assemblies described herein may be used alone or in combination with other devices. It is to be expected that various equivalents, alternatives and modifications are possible within the scope of any appended claims.

What is claimed is:

1. A method for providing real-time coaching assistance during a competition, the method comprising:
providing a gameplay profile containing rules for competing in the competition;
receiving input data relating to the competition via an input device in real-time;
analyzing in real-time via a processing module the input data in view of the gameplay profile for the competition;
automatically generating coaching outputs in real-time based on the analysis of the input data; and
displaying in real-time the coaching outputs on a display device;
wherein the coaching outputs include performance statistics for a plurality of players, and also include an attempt projection for a future event to occur during the competition; and
wherein the real-time coaching assistance is provided by displaying the coaching outputs.

2. The method according to claim 1, wherein the coaching outputs further include coaching recommendations based on the analysis of the input data, and wherein the coaching recommendations include at least one of a play to be called and a change in use of own players within the plurality of players.

3. The method according to claim 2, wherein the coaching recommendations include a substitution for which of the own players to cover an opponent player within the plurality of players.

4. The method according to claim 2, further comprising storing video footage of at least one of the plurality of player, wherein the video footage is displayable on the display device, and wherein the coaching recommendations include a recommended video within the video footage to be displayed on the display device based on the analysis of the input data.

5. The method according to claim 1, wherein the coaching outputs further include coaching warnings indicating that one of the rules stored within the gameplay profile is being violated.

6. The method according to claim 1, wherein the coaching outputs include a fatigue score for at least one of the plurality of players.

7. The method according to claim 1, wherein the input data includes locations within a play area map for each of the plurality of players in real-time.

8. The method according to claim 7, further comprising dividing the play area map into zones, and further comprising analyzing the input data for each of the plurality of players to determine the performance statistics for each of the plurality of players specific to the zones.

9. The method according to claim 7, further comprising displaying the locations of the plurality of players within the play area map in real-time.

10. The method according to claim 9, further comprising assigning and displaying an indicator in real-time for each of the plurality of players within the play area map, wherein the indicators are indicative of the performance statistics for each of the plurality of players, respectively.

11. The method according to claim 7, wherein for each of the plurality of players the performance statistics include the probability of scoring from each of the zones and the attempt projections include the probability of attempting to score from each of the zones.

12. The method according to claim 11, further comprising assigning and displaying in real-time coding for each of the plurality of players within the play area map, wherein the coding is indicative of the performance statistics for each of the plurality of players, respectively.

13. The method according to claim 1, wherein the input device is a video camera.

14. The method according to claim 1, further comprising storing the coaching outputs of the competition as historic data, wherein the historic data is receivable among the input data for a future competition.

15. The method according to claim 1, wherein the input data further includes external data relating to at least one of weather, day, and time of day conditions for the competition.

16. A non-transitory medium having instructions thereon for providing real-time coaching assistance during a competition that, when executed by a processing device, causes a computing device operated by a user to:
access a gameplay profile containing rules and a play area map for the competition;
receive input data relating to the competition via an input device in real-time;
analyze in real-time the input data in view of the gameplay profile for the competition;
automatically generate coaching outputs in real-time based on the analysis of the input data, wherein the coaching outputs include performance statistics for a plurality of players and also an attempt projection for a future event to occur during the competition; and
displaying in real-time the coaching outputs on a display device to thereby provide real-time coaching assistance.

17. The non-transitory medium according to claim 16, further causing the computing device to access and recommend a recommended video within stored video footage of at least one of the plurality of players, wherein the recommendation of the recommended video is based on the analysis of the input data.

18. The non-transitory medium according to claim 16, wherein the coaching outputs further include coaching recommendations based on the analysis of the input data, wherein the coaching recommendations include a type of defense to employ.

19. The non-transitory medium according to claim 16, wherein the play area map is divided into zones, wherein the performance statistics for each of the plurality of players, for each of the zones.

20. The non-transitory medium according to claim 19, further comprising displaying the locations of the plurality of players within the play area map in real-time, and coding the display for each of the plurality of players according to the performance statistics corresponding thereto.
